(19) United States
(12) Patent Application Publication
(10) Pub. No.: US 2013/0079484 A1
(43) Pub. Date: Mar. 28, 2013

(54) ORGANIC-INORGANIC HYBRID POLYMER HAVING QUANTUM WELL STRUCTURES

(71) Applicants: Hyun-Dam JEONG, Gwangju (KR); HONG LAE SOHN, Gwangju (KR); Jin-Kyu CHOI, Yeosu-si (KR); Seung Hyun JANG, Gwangju (KR)

(72) Inventors: Hyun-Dam JEONG, Gwangju (KR); HONG LAE SOHN, Gwangju (KR); Jin-Kyu CHOI, Yeosu-si (KR); Seung Hyun JANG, Gwangju (KR)

(73) Assignee: MOLECULAR ELECTRONICS CONSULTING, Gwangju (KR)

(21) Appl. No.: 13/425,515

(22) Filed: Mar. 21, 2012

(30) Foreign Application Priority Data
Sep. 22, 2011 (KR) 10-2011-0095964

(51) Int. Cl. C08G 77/04

(52) U.S. Cl. 528/43

(57) ABSTRACT

Provided is poly(tetraphenyl)silole siloxane having quantum well structures, and thus, organic-inorganic hybrid polymers having these quantum well structures are applied to electronic devices, which allows flexible non-volatile TFT memory devices to be realized.

### CROSS-REFERENCE TO RELATED APPLICATIONS

This application claims priority under 35 U.S.C. §119 to Korean Patent Application No. 10-2011-0095964, filed on Sep. 22, 2011, in the Korean Intellectual Property Office, the disclosure of which is incorporated herein by reference in its entirety.

### TECHNICAL FIELD

The following disclosure relates to a noble organic-inorganic hybrid polymer having physical flexibility and allowing electron trapping and electron transfer.

### BACKGROUND

As foldable or wearable computers, electronic papers, and the like, recently become as the next generation in technology, many studies have been conducted on electronic devices (flexible electronic devices) that are operable on a flexible substrate such as plastic or the like.

For implementing these electronic devices, the development of new materials capable of exhibiting functions of the existing devices on bendable substrates or under the specific manufacture processes is needed.

Organic-inorganic hybrid polymers are materials in which organic and inorganic moieties are mixed at a molecular level to give superior mechanical, thermal, optical, and electrical properties, as compared with the materials made entirely from either organic or inorganic components only.

Polyorganosiloxanes are one of the most representative organic-inorganic hybrid polymers in which organic groups and inorganic —Si—O—Si— moieties are connected by Si—C covalent bonds. These organic-inorganic hybrid polymers are easily synthesized from monomers containing Si—C bonds under the acidic (or basic) catalyst, as shown in Reaction Scheme 1 below.

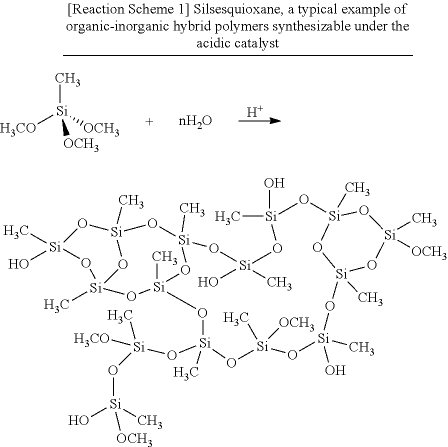

Polyorganosiloxanes are dielectric materials, and electric polarization occurs therein when external electric field is applied thereto. Most insulator materials may be dielectrics since they exhibit an electric polarization phenomenon when applying an electric field. Specifically, most of the materials containing Si—O bonds, such as polyorganosiloxanes, are not only insulators owing to high band gap values but also dielectrics due to polarization by external electric field.

In polyorganosiloxanes, which are one of the most representative organic-inorganic hybrid polymers, various organic groups and inorganic —Si—O—Si— groups are covalently connected to each other. The organic groups in polyorganosiloxanes have molecular-free volumes, and thereby function to decrease a refractive index and a dielectric constant.

It has been known that the high dielectric constant in silicate-silsesquioxane is attributed to orientation polarization due to the existence of Si—OH groups, which may be explained using Debye's equation, and the high refractive indices of methylene-biphenylene-bridged silsesquioxane materials are attributed to high electronic polarization of methylene-biphenylene-bridged groups. In addition, as described in Korean Patent Laid-open Publication No. 10-2007-0078894 (Patent Document 1), charge storage characteristics of dielectrics are importantly studied in that they are applicable as memory devices.

For this reason, the development of new materials for implementing memory devices, which are necessary in electronic devices, on a flexible substrate becomes important.

In order to realize non-volatile memory functions on the flexible substrate, it is necessary to invent organic-inorganic hybrid materials capable of storing and holding charges. The researchers of the world have mainly tried to store charges in inorganic nanoparticles mixed with the existing polymers, but the organic-inorganic hybrid materials based on these inorganic nanoparticles have phase separation problems generated due to agglomeration of the inorganic nanoparticles and deficiency in electric stability due to defective structures of interfaces between the inorganic nanoparticles and the polymers.

### CITED DOCUMENTS

### Patent Document

(Patent Document 1) Korean Patent Laid-Open Publication No. 10-2007-0078894

### SUMMARY

An embodiment of the present invention is directed to providing a noble organic-inorganic hybrid material allowing charge trapping and transfer and having excellent physical flexibility and electric stability.

The present inventors have deeply studied memory materials applicable to flexible devices, with the result that a noble organic-inorganic hybrid polymer having quantum well structures for trapping electrons therein was successively realized by inserting —Si—O—Si— linkages having superior insulation property due to high band gap values into silole molecules capable of capturing electrons therein due to superior electron affinity, and then filed the present application.

Further, the present invention provides electric properties of the organic-inorganic hybrid polymer, and thus realizes electronic devices using the organic-inorganic hybrid polymers according to the present invention.

The present invention provides an organic-inorganic hybrid polymer having quantum well structures, which is expressed by Chemical Formula 1 below:

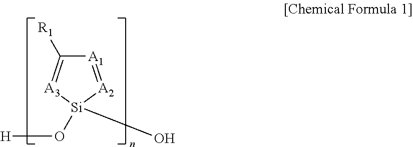

wherein in Chemical Formula 1, A₁, A₂, and A₃ each are CR₂, CR₃, CR₄ or N; R₁, R₂, R₃, and R₄ each are hydrogen, aryl, alkyl, cycloalkyl, or heteroaryl, or may be linked to an adjacent substitution among R₁, R₂, R₃, and R₄, via C₃-C₇ alkylene or C₃-C₇ alkenylene to form a fusion ring; and n is a natural number of 2˜100.

More specifically, the present invention provides an organic-inorganic hybrid polymer having quantum well structures, which is expressed by Chemical Formula 2 below.

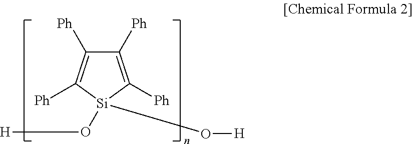

where in Chemical Formula 2, n is a natural number of 2˜100.

The siloxane polymer of Chemical Formula 2 is poly(tetraphenyl)silole siloxane, and the poly(tetraphenyl)silole siloxane according to the present invention has a weight average molecular weight (Mw) in the range of 800-50000.

In the electron structure of the poly(tetraphenyl) silole siloxane according to the present invention, well layers are formed by (tetraphenyl) silole molecules of the poly(tetraphenyl) silole siloxane, and barrier layers are formed by Si—O—Si linkages of the poly(tetraphenyl) silole siloxane.

As described above, in the poly(tetraphenyl) silole siloxane according to the present invention, the well layers are formed by the (tetraphenyl) silole molecules and the barrier layers are formed by Si—O—Si linkages having a high band gap value, and thereby to form well structures allowing charge trapping.

Specifically, the poly(tetraphenyl) silole siloxane according to the present invention has quantum well electron structures as shown in FIG. 1, due to the low LUMO energy level of (tetraphenyl) silole molecules and the high HOMO-LUMO gap of Si—O—Si linkages that are alternately located therein.

More specifically, the poly(tetraphenyl) silole siloxane according to the present invention has a structure in which (tetraphenyl) silole molecules are linked via Si—O—Si linkages by polymerization, as shown in Chemical Formula 2, and thus, has a structure in which barrier layers (Si—O—Si linkage units) and well layers (silole molecules) are alternatively disposed, resulting in well structures of a barrier layer (Si—O—Si linkage unit)-a well layer ((tetraphenyl) silole molecule)-a barrier layer (Si—O—Si linkage unit).

Since the barrier layers (Si—O—Si linkage units) and well layers ((tetraphenyl) silole molecules) are alternately formed by polymerization of monomers, as shown in Chemical Formula 2, the poly(tetraphenyl) silole siloxane according to the present invention has quantum wells, the number of which is the same as that of monomers of Chemical Formula 2.

The poly(tetraphenyl)silole siloxane according to the present invention is characterized in that charges tunnel the barrier layers when external electric field is applied thereto. Here, the charge transfer covers a case where charges trapped in the well layer tunnel the barrier layer and transfer to the outside (outer conducting wirings) of the poly(tetraphenyl) silole siloxane, a case where externally injected charges tunnel the barrier layer and transfer to the well layer, and a case where the charges trapped in the well layer tunnel the barrier layer and transfer to an adjacent well layer.

In addition, the present invention provides a thin film obtained by coating and curing a solution containing the poly(tetraphenyl) silole siloxane.

Here, the solution is not particularly limited as long as the poly(tetraphenyl)silole siloxane is dissolved therein, but tetrahydroxyfurane (THF), hexane, methylenechloride, or the like may be used.

Preferably, the solution containing the poly(tetraphenyl)silole siloxane contains 1˜20 wt % of the poly(tetraphenyl) silole siloxane.

In the thin film according to the present invention, electric properties of the cured thin film vary depending on the curing conditions for the coating film in which the solution containing the poly(tetraphenyl)silole siloxane is coated, and charge transfer characteristics are remarkably improved under the particular curing conditions.

Specifically, a physical distance between well layers of poly(tetraphenyl) silole siloxane in the thin film varies depending on the curing conditions for the coating film, and thus, the charge transfer rate is controlled.

The curing is characterized by being performed at 100° C.-350° C. The curing at 100° C. or lower may cause an abrupt drop in refractive index, and the curing at 350° C. or higher may cause thermal decomposition of organic groups of poly(tetraphenyl) silole siloxane according to the present invention, thereby failing to obtain a desired thin film. FIG. 6 shows changes in refractive index and thin film thickness according to curing temperatures.

The thin film according to the present invention has a refractive index of 1.55˜1.62.

The thin film according to the present invention has a dielectric constant of 3.0˜3.5.

The thin film according to the present invention has a flat band shift (ΔV_{FB}) of 1˜20 V.

The thin film according to the present invention has charge trap density of 0.03˜0.06 C/cm⁸.

More preferably, the curing temperature is 100% D-150% D.

A distance between two phenyl groups of one poly(tetraphenyl) silole siloxane monomer and an adjacent (tetraphenyl) silole siloxane monomer, which are contained in the thin film according to the present invention, may be 0.2˜0.5 nm.

Here, the higher the curing temperature, the smaller the distance between the phenyl groups, and thus, the electron transfer rate between polymer chains increases, with the result that the amount of electrons trapped in the quantum well structures are somewhat reduced. However, charge trap effect itself due to the quantum well structures does not disappear.

In addition, electronic devices having the thin film are included within the scope of the present invention.

The electronic devices may be selected from organic thin film transistors (OTFT), non-volatile memory sensors, logic circuits, memory circuits, tuning circuits, solar cells, flexible transistor devices, flexible transistor memories, and the like.

The poly(tetraphenyl)silole siloxane according to the present invention may be prepared by a preparing method, comprising:

a) obtaining dihydroxy(tetraphenyl)silole by using dichloro(tetraphenyl)silole; and
b) dissolving and precipitating poly(tetraphenyl)silole siloxane generated by polymerization under reflux of the dihydroxy(tetraphenyl)silole under reflux in step a).

This is specifically displayed by Reaction Scheme 2 below:

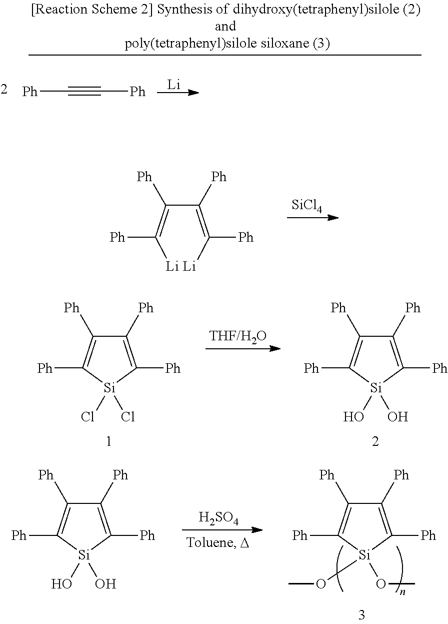

Step a) will be described in more detail as follows. Dichloro(tetraphenyl)silole (1) is dissolved into a solvent, and stirred in an inert gas atmosphere. The resulting mixture is extracted, followed by washing, filtering, and distillation under reduced pressure, thereby giving pure dihydroxy(tetraphenyl)silole (2).

The solvent is not particularly limited as long as the dichloro(tetraphenyl)silole (1) can be dissolved therein, but aqueous THF or the like may be used.

In addition, argon (Ar) or the like may be used as the inert gas.

Step b) will be described in more detail as follows. The dihydroxy(tetraphenyl)silole (2) is dissolved in a solvent, followed by polymerization under reflux (condensation). The solvent is removed through distillation under reduced pressure. The residual solid is subjected to dissolution and precipitation procedures, thereby obtaining a poly(tetraphenyl)silole siloxane (3) powder.

The polymerization under reflux may be conducted by addition of a solvent and a catalyst.

Here, the solvent is not particularly limited as long as the dihydroxy(tetraphenyl)silole (2) can be dissolved therein, but THF or the like may be used.

The catalyst is not particularly limited, but a sulfuric acid catalyst or the like may be preferably used.

Here, the polymerization is preferably performed at 65˜67° C. for 2 hours or longer.

In the dissolution and precipitation procedures, the solid that remains after the solvent is removed by distillation under reduced pressure is dissolved in a soluble solvent, and then precipitated by being mixed with a non-soluble solvent such as hexane.

### BRIEF DESCRIPTION OF THE DRAWINGS

FIG. 1 shows a quantum well structures model for explaining charge transfer through poly(tetraphenyl)silole siloxane.

FIG. 2 shows a molecular orbital energy diagram.

FIG. 3 shows a quantum well structures model of poly(tetraphenyl)silole siloxane (n=7).

FIG. 4 shows TGA results of poly(tetraphenyl)silole siloxane.

FIG. 5 shows FT-IR results of poly(tetraphenyl)silole siloxane thin film according to curing temperatures.

FIG. 6 shows changes in refractive index and thickness of the poly(tetraphenyl)silole siloxane thin film according to curing temperatures, which is measured through SE.

FIG. 7 shows a molecular orbital energy diagram with respect to the Fermi energy level (EF) of the poly(tetraphenyl)silole siloxane thin film formed from 4 wt % solution.

FIG. 8 shows a change in chemical composition of the poly(tetraphenyl)silole siloxane thin film, according to curing temperatures, investigated from XPS analysis results.

FIG. 9 shows capacitance-voltage (C-V) curves for the poly(tetraphenyl)silole siloxane thin film according to curing temperatures.

FIG. 10 shows C-V mechanisms according to steps, using the energy diagrams of quantum well structures.

, FIG. 11 shows a model of intermolecular interaction considering van der Waals thickness of phenyl rings.

FIG. 12 shows a logarithmic relationship of ΔV_{FB} and thickness (t).

FIG. 13 shows changes in distance between chains (s) and distance between phenyl rings (d) in the kinetically preferred state and the thermodynamically preferred state.

FIG. 14 shows an electron transfer kinetics model at a negative bias voltage for the forward sweep direction.

FIG. 15 shows geometric models for describing cofacial interaction between two phenyl rings of adjacent polymer chains.

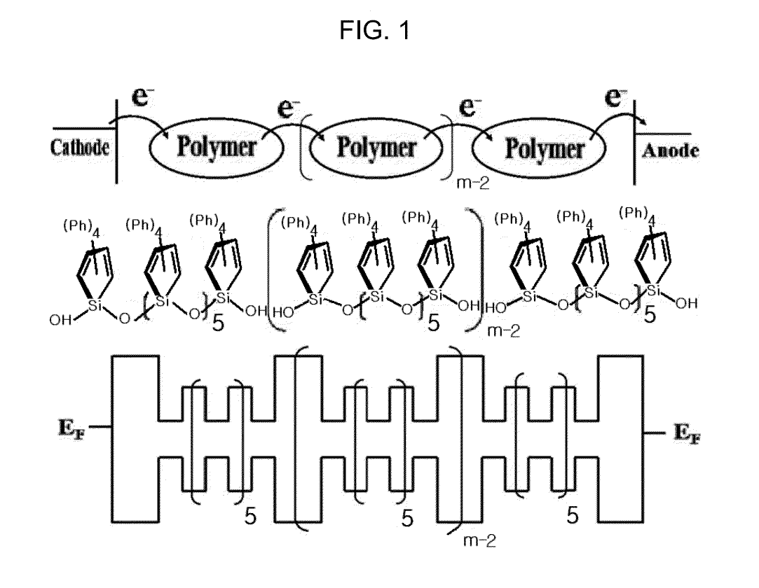

### DETAILED DESCRIPTION OF EMBODIMENTS

Geometries of all the molecules calculated in the present invention were pre-optimized using a PM3 semi-empirical method in the Hyperchem 8.0 package, and then were fully optimized using the density functional theory (DFT) at the B3LYP (Becke, three-parameter, Lee-Yang-Parr) level and 6˜31G** basis set in the Gaussian03 package.

### Synthesis of Dihydroxy(Tetraphenyl)Silole and Poly(Tetraphenyl)Silole Siloxane

The synthesis procedure was schematically shown in Reaction Scheme 2. Dichloro(tetraphenyl)silole (1) (2.0 g, 4.5 mmol) was dissolved into 50 mL of aqueous THF (THF/H₂O=1/4), and stirred at room temperature for 2 hours under argon (Ar) atmosphere. The resulting mixture was then extracted with ether. The extract was washed with distilled water and brine, and then dried over anhydrous Mg₂SO₄ to remove water, followed by filtering. The filtrate was distilled under reduced pressure to give pure dihydroxy(tetraphenyl)silole (1.76 g, 4.2 mmol) in 94% yield as a bright-green solid (¹H-NMR (CDCl₃) δ=6.8-7.2 (m, 20H), 3.0 (s, 2H)).

The poly(tetraphenyl)silole siloxane (3) was synthesized from the dihydroxy(tetraphenyl)silole (2). Dihydroxyl(tetraphenyl)silole (2) (1.0 g, 2.3 Mmol) was dissolved in 50 mL of THF, and then refluxed with 3.0 mL of sulfuric acid (H₂SO₄) as a catalyst for polymerization (condensation) over 2 hours while the temperature of 66° C. was maintained. The solvent was removed by distillation under reduced pressure. The residual solid was dissolved in 5.0 mL of THF, and mixed into 100 mL of hexane. After three cycles of these dissolution-precipitation procedure, 0.6 g of poly(tetraphenyl)silole siloxane (3) was obtained in 60% yield as a light-brown powder.

### Formation of Poly(Tetraphenyl)Silole Siloxane Thin Film

A 4 wt % poly(tetraphenyl)silole siloxane solution was prepared by putting 0.078 g of poly(tetraphenyl)silole siloxane in 1.87 g of THF, followed by stirring in an air atmosphere for 5 min. This solution was filtered (PTFE, 0.2 μm), and spin-coated on a p-type silicon substrate (2000 rpm, 25 seconds), and thereby to form poly(tetraphenyl)silole siloxane thin films. The thus formed thin films were heated at 80° C. for 10 min in air atmosphere to remove all remaining solvent. Finally, the thin films were cured in a vacuum tube furnace under a pressure of approximately 1.0×10⁻² torr for 1 hour at the following temperatures, respectively: 100, 150, 200, and 350° C.

The poly(tetraphenyl)silole siloxane prepared by the above preparing method was analyzed and measured by the following methods.

1. Gel permeation chromatography (GPC)

The molecular weight of poly(tetraphenyl)silole siloxane was measured by gel permeation chromatography (GPC) (Perkin-Elmer series 200). Varian Polymer Laboratories columns (PL gel 5 μm Mixed-C and Mixed-D) were used, and freshly distilled THF was used as the eluent. The molecular weight thereof was calibrated by using polystyrene standards (Varian, Easical PS-1).

### 2. Nuclear Magnetic Spectroscopy (NMR)

All NMR analyses were conducted by using Bruker 300 MHz spectrometers (300.1 MHz for ¹H-NMR and 75.5 MHz ¹³C-NMR). Tetramethylsilane (TMS) standards were used at 0.00 ppm, and CDCl₃ was used as NMR solvents.

### 3. Fourier Transform Infrared Spectroscopy (FT-IR)

The molecular structure of poly(tetraphenyl)silole siloxane was analyzed by using FT-IR (Nicolet 380). The measurements were conducted in the measurement range of 4000˜400 cm⁻¹ at a spectral resolution of 7.7 cm⁻¹ in the transmittance mode.

### 4. Thermogravimetric Analysis (TGA)

TGA was performed on a METTLER TOLEDO SDTA851e. The poly(tetraphenyl)silole siloxane powder was placed on an aluminum oxide (AlOx) TGA pan, and then cured from 30° C. to 800° C. at a rate of 10° C./min in the nitrogen gas atmosphere (50 mL/min).

### 5. X-Ray Photoelectron Spectroscopy (XPS)

The compositional change in the thin film according to the curing temperature was analyzed by using XPS. The XPS analysis was conducted on a MultiLab 2000, using a Mg Kα′ (1253.6 eV) source of a pass energy of 20 eV as a light source under a pressure of 1.0×10⁻⁹ torr. In order to remove impurities on surfaces of samples prior to measurements, the surfaces of the samples were cleaned for approximately 2 min by using an Ar⁺ ion gun sputtering at a power of 2 kV and 1.3 μA.

### 6. Spectrscopic Ellipsometry (SE)

The thicknesses and refractive indices of the poly(tetraphenyl)silole siloxane thin films with each curing temperature were measured by SE (M2000D, J. A. Wollam Co. Inc., USA).

### 7. Capacitance-Voltage (C-V) Measurement

For capacitance-voltage (C-V) measurement, an MIS structure was manufactured by using aluminum metal for a top electrode, a poly(tetraphenyl)silole siloxane thin film for an insulator, and low doped silicon water for a semiconductor. Here, the aluminum electrode was thermally deposited. A back surface of the silicon wafer was also coated with aluminum metal to reduce contact resistance.

An HP4284 LCR meter was used to obtain the C-V curves by applying an alternating current (AC) voltage with a frequency of 1 MHz and an amplitude of 1 V to the top aluminum electrode, with a direct current (DC) voltage in the range of −35V to 35V. The C-V curves were measured in both forward and reverse directions, in order to investigate the charge trap mechanism of the poly(tetraphenyl)silole siloxane thin film.

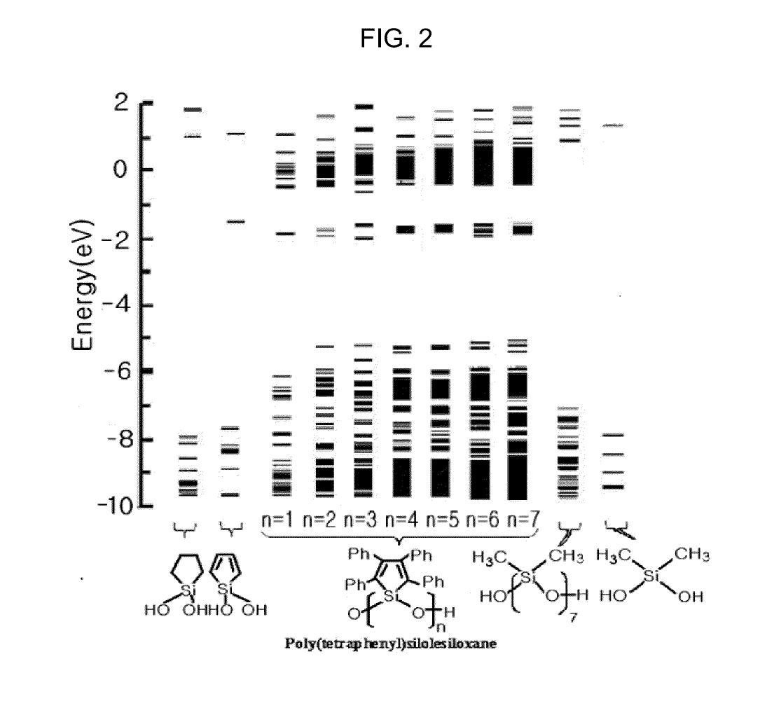

FIG. 2 shows the comparison among the DFT-calculated orbital energy levels of dihydroxy silacyclopentane, dihydroxysilole, dihydroxy(tetraphenyl)silole, poly(tetraphenyl)silole siloxanes having 2 to 7 (tetraphenyl)silole monomers, and polydimethylsiloxane (2 eV˜−20 eV). The highest occupied molecular orbitals (HOMOs) and lowest unoccupied molecular orbitals (LUMOs) are denoted by green and red colors, respectively. By comparing calculation results of dihydroxy silacyclopentane and dihydroxysilole, the HOMO energy becomes increased and the LUMO energy becomes decreased through addition of n-bonds into the silacyclopentyl ring. Here, the low LUMO energy of silole (=silacyclopentane) is partly due to the σ*-π* conjugation between the σ* orbital of the silicon atom and the π* orbital of the butadiene.

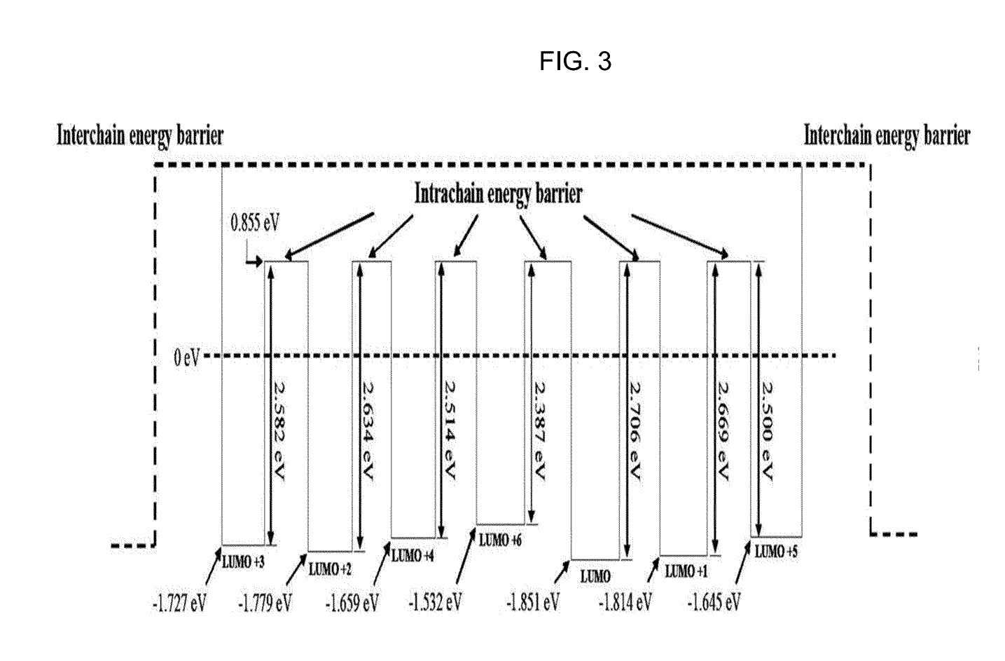

FIG. 3 shows a quantum well structure model simply expressed by using the energies and orbital shapes of LUMO to LUMO+6 of poly(tetraphenyl)silole siloxane (n=7). As shown in FIG. 3, through the siloxane chain, there are seven quantum well structures possessing different energy values. These quantum well structures consisting of LUMO levels are determined to be an origin for trapping (−) charges (that is, electrons) of the poly(tetraphenyl)silole siloxane molecule. As shown in FIG. 3, the interchain energy barrier was displayed as a dotted line, and it is thought that this is not actually one-dimensional but surrounds the polymer chain in three-dimensional space. It is determined that the width and height of the interchain energy barrier depends mainly on the (tetraphenyl)silole rings of the two adjacent polymer chains and the charge transfer rate between the polymer chains, which is one of the decisive control factors of the electron trapping characteristics, is more affected by the interchain energy barriers than by the intrachain energy barriers.

### 1) Analysis Results of Poly(Tetraphenyl)Silole Siloxane—GPC Analysis

As the result of GPC analysis, the weight average molecular weight (Mw) and polydispersity index (Mw/Mn) of poly(tetraphenyl)silole siloxane were measured at approximately 3080 and 1.18, respectively. It can be seen that, since the molecular weight of the dihydroxy(tetraphenyl) silole, which is a monomer, is 418.6, the poly(tetraphenyl)silole siloxane consists of approximately seven monomers on average.

Nuclear Magnetic Resonance (NMR) Results

¹H-NMR (300.133 MHz, CDCl₃): 6.45-7.19 (br, m, Ph), 1.42 (s, OH). ¹³C-NMR (75.403 MHz, CDCl₃ (77.00)): 53.6 (s, OMe), 125-130 (m, silole C), 137-137 (br, m, Ph).

Thermogravimetric Analysis (TGA) Results

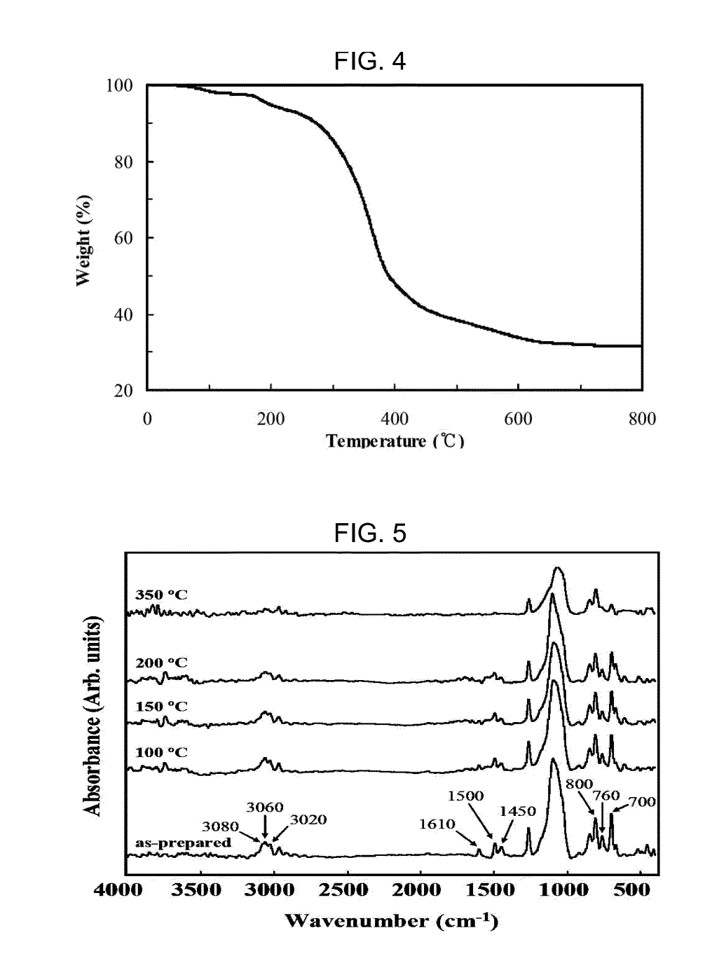

FIG. 4 shows Thermogravimetric analysis (TGA) results of the poly(tetraphenyl)silole siloxane thin film. The weight loss of the poly(tetraphenyl)silole siloxane of the present invention occurred at approximately 90° C., and this is thought to be due to evaporation of physisorbed water molecules. In addition, the secondary weight loss thereof occurred approximately 170° C., and this is thought to be due to evaporation of water by the condensation reaction of silanol (silacyclopentadiene (silole)nol; Si—OH) groups at the polymer terminals. This condensation reaction can be also expected through FT-IR results of the poly(tetraphenyl)silole siloxane thin films according to curing temperatures, which will be mentioned below. Above 280° C., a huge loss in weight was observed, and this is thought to be due to thermal decomposition of the organic groups.

2) Analysis Results of Poly(Tetraphenyl)Silole Siloxane thin Films

FT-IR Analysis Results

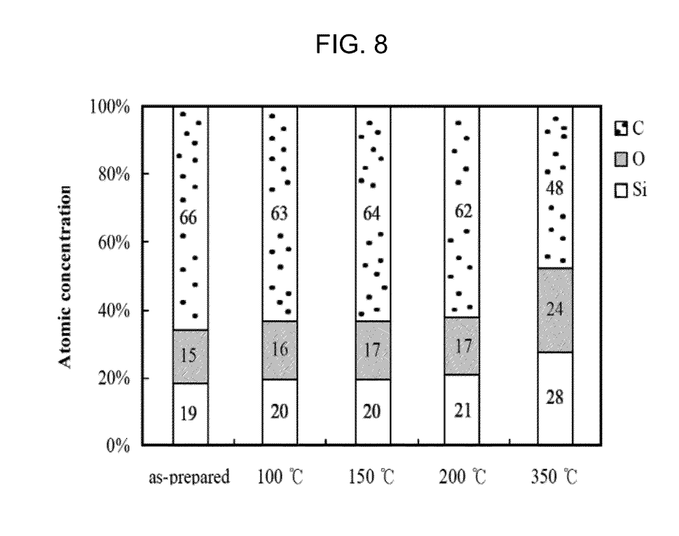

FIG. 5 shows FT-IR results of the poly(tetraphenyl)silole siloxane thin film according to curing temperatures. As the measurement results of “as-prepared” samples, the presence of phenyl groups in the thin film can be confirmed through the sp²-hybridized C—H stretching at 3080, 3060, and 3020 cm⁻¹ and C—H bending peaks in the monosubstituted aromatic ring at 760 and 700 cm⁻¹. It can be seen that, as the curing temperature increased, the organic groups gradually decreased due to thermal decomposition and most of the organic groups were thermally decomposed at 200° C. or higher. This thermal decomposition of organic groups can be confirmed through the following XPS results (FIG. 8). The phenyl groups and silole rings in the thin film were confirmed through C═C stretching in the range of 1600˜1400 cm⁻¹. The peaks at 1200˜1000 cm⁻¹ are attributed to antisymmetric stretching of Si—O—Si, and the peak at 800 cm⁻¹ is attributed to asymmetric stretching thereof. The terminal Si—OH groups were detected at approximately 920 cm⁻¹, and it can be seen that intensity thereof decreased with increasing curing temperature. This is an indirect proof of the condensation reaction occurring in the thin film.

SE Analysis Results

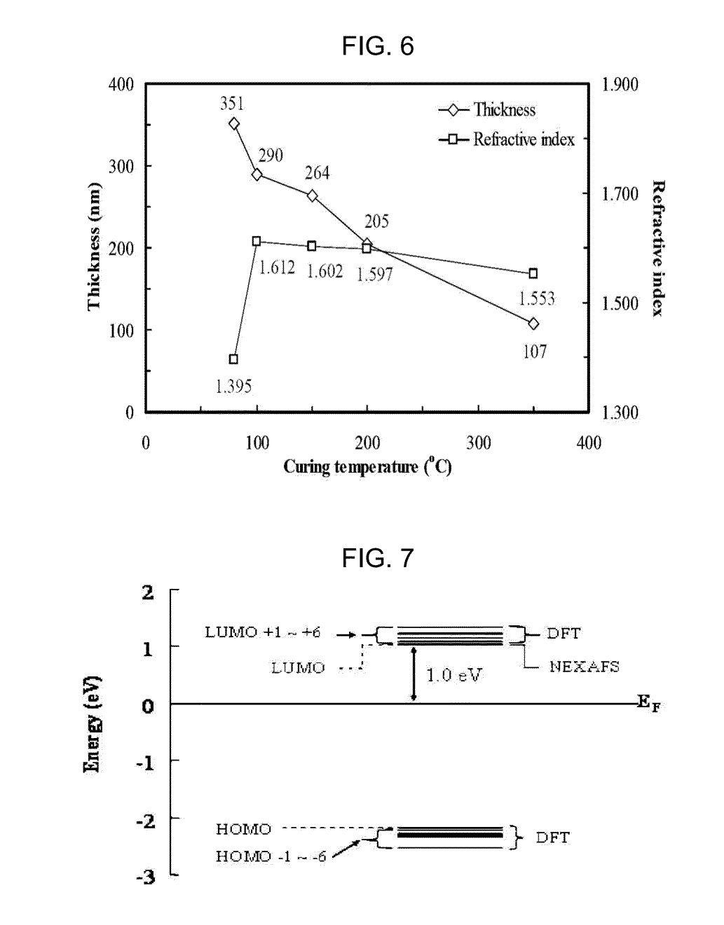

FIG. 6 shows changes in refractive index and thickness of the poly(tetraphenyl)silole siloxane thin film according to curing temperatures, by using SE. It can be seen that the refractive indices abruptly increased as the curing temperature increased from 80° C. to 100° C., while slightly decreasing with the increasing curing temperature at loot or higher. The refractive index has a proportional relationship with density of the thin film, which may be understood by the following Lorenz-Lorentz equation:

$$( \frac{{n}^{2} - 1}{{n}^{2} + 2} ) = \frac{\sum {N}_{j} \cdot {α}_{j ( electronic )}}{3 {ɛ}_{0}} \qquad ( 3 )$$

where, n is refractive index, N_{J} is density, α_{j(electronic)} is electronic polarizability, and ∈₀ is vacuum permittivity.

C-V measurement results and electron trap properties analysis results

The capacitance-voltage (C_V) curves were obtained in metal-insulator-semiconductor (MIS) structures. The thermally deposited aluminum and p-type silicon wafers were used as the metal and semiconductor, respectively.

Under the negative bias voltage, the holes that were major carriers in the p-type silicon wafer move to gather at the interface between the insulator layer and the silicon wafer, and this is expressed as the “accumulation region” in the typical capacitance-voltage (C-V) curve. Here, the thickness (d) of the insulator may be directly used to calculate dielectric permittivity (∈) thereof, as shown in the following equation:

$$C = ɛ {ɛ}_{0} \frac{Λ}{d} \\ {ɛ}_{0} = 8.854 \times {10}^{- 12} F \text{/} m \qquad ( 4 )$$

where, C is accumulation capacitance in the accumulation region,. A is area of the electrode, and d is thickness of the insulator. ∈ and ∈₀ are dielectric permittivity of the insulator and vacuum dielectric permittivity, respectively.

In contrast, under the positive bias voltage, the holes of the silicon wafer move not to the interface between the insulator layer and the silicon wafer but in the direction contrary to this, and thus, the depletion layer is formed at the interface between the insulator layer and the silicon wafer, which is expressed as the “depletion region” in the C-V curve. The thickness of the depletion layer (d_{dep}) generated herein needs to be considered to calculate the dielectric permittivity, as shown in the following equation:

$$C = {ɛɛ}_{0} \frac{Λ}{d + {d}_{dep}} \\ {ɛ}_{0} = 8.854 \times {10}^{- 12} F \text{/} m \qquad ( 5 )$$

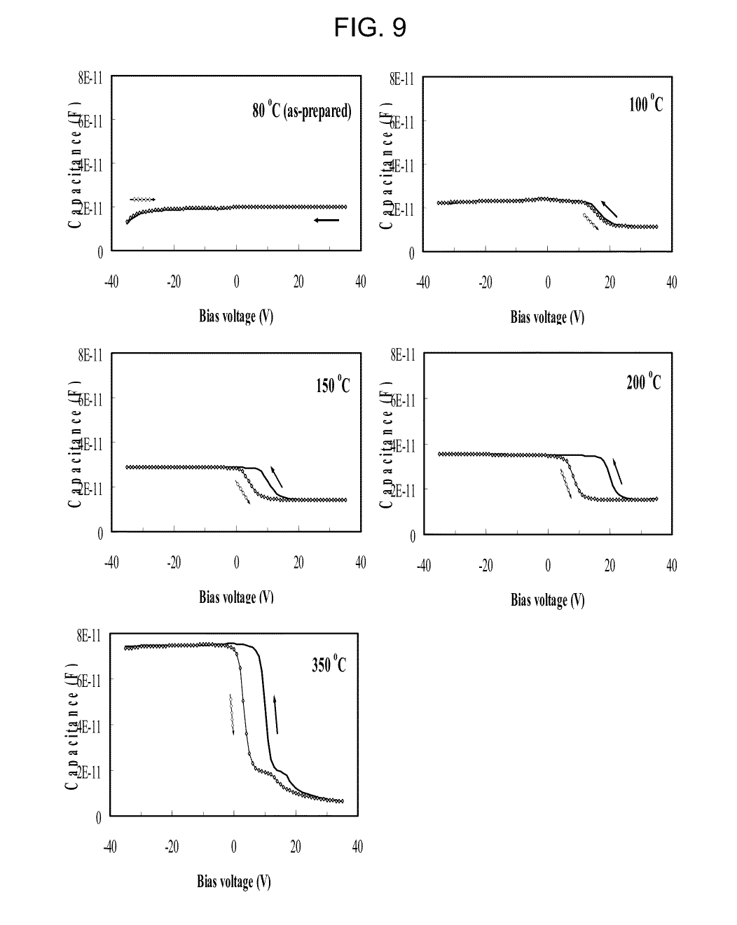

FIG. 9 shows C-V measurement results of the poly(tetraphenyl)silole siloxane thin film according to curing temperatures. The positive flat band shift (ΔV_{FB}) was observed at all temperature conditions, and this means that negative charges (electrons) were trapped. The reason is that the poly(tetraphenyl)silole siloxane has LUMO energy levels (low LUMO energy) of high electron affinity. The “as-prepared” sample showed only a flat curve, and this means that ΔW_{FB,tot}(total flat band shift) is greater than 35V, which is an experimentally applied voltage. The dielectric constants of the poly(tetraphenyl)silole siloxane thin film according to curing temperatures were calculated by using the accumulation capacitance of the accumulation region in the C-V curve and the thickness obtained from SE measurement (Table 1).

From the ΔV_{FB,tot} values of the C-V curve, volume density of the trapped charges (ρ; charge trap density) was calculated using the following equation. The ΔV_{FB,tot} is divided into four specific terms according to the causes thereof as follows:

ΔV_{FB,tot}=ΔV_{FB,1}+ΔV_{FB,2}+V_{FB,3}+ΔV_{FB,4} (6)

ΔV_{FB,1} is due to a difference in work function between the aluminum and the silicon substrate, which was known to be −0.8 eV, as mentioned above. The value ΔV_{FB,2} is due to the charges trapped in the thin film, and ΔV_{FB,3} and ΔV_{FB,4} are due to structural defects from silicon during oxidation and interface trapped charges, respectively. Assuming that ΔV_{FB,3} and ΔV_{FB,4} are very small:

ΔV_{FB,2}=ΔV_{FB,tot}+0.8V (7)

The relationship between ΔV_{FB,2} and charge trap density (ρ) is expressed by the following equations:

$$Δ {V}_{FB , 2} = - {\int }_{0}^{t} \frac{ρ ( x ) \cdot x \cdot d x}{{ɛ}_{0} \cdot {ɛ}_{OX}} \qquad ( 8 )$$

Here, assuming that ρ(x) is also uniform according to x, ρ(x)=ρ:

$$Δ {V}_{FB , 2} = - \frac{ρ}{{ɛ}_{0} \cdot {ɛ}_{OX}} {\int }_{0}^{t} x d x = - \frac{ρ}{{ɛ}_{0} \cdot {ɛ}_{OX}} \frac{1}{2} {t}^{2} \qquad ( 9 )$$

Thus, the trap density (|ρ|) of negative charges (|ρ|) is estimated from ΔV_{FB,2}:

$$\vert ρ \vert = \frac{2 {ɛ}_{0} \cdot {ɛ}_{OX}}{{t}^{2}} ( Δ {V}_{FB , 2} ) \qquad ( 10 )$$

The charge trap densities in both cases of reverse and forward sweep directions were summarized in Table. 1. In the low curing temperature ranges of up to 150° C., the charge trap density (|ρ|) decreased as the curing temperature increased. It may be thought that this is related to the change in the nanoscopic arrangement of the polymer chains according to the curing temperature. This state was defined as a thermodynamically preferred state. The thermodynamically preferred state becomes dominant while the temperature increases within the temperature of up to 150° C. Thus, the cofacial π-π interaction between the phenyl groups is greatly enhanced, and thereby increases the charge transfer rate, resulting in a decrease in the charge trap density (|ρ|).

TABLE 1
Dielectric constant, flat band shift (ΔV_{FB,2}), and negative
charge density of poly(tetraphenyl)silole siloxane thin film according
to the curing temperature

| | | | | | Forward | |
|---|---|---|---|---|---|---|
| Curing | Thick- | Di- | Reverse sweep | | sweep | |
| temp. | ness | electric | | \|ρ\| | ΔV_{FB,2} | \|ρ\| |
| ( ) | (nm) | constant | ΔV_{FB,2} (V) | (C · cm⁻³) | (V) | (C · cm⁻³) |
| 80 | 351 | 3.00 | >35.8 | >0.015 | >35.8 | >0.015 |
| 100 | 290 | 3.02 | 15.9 | 0.010 | 14.4 | 0.009 |
| 150 | 264 | 3.28 | 9.7 | 0.008 | 3.5 | 0.003 |
| 200 | 205 | 3.32 | 19.7 | 0.028 | 7.7 | 0.011 |
| 350 | 107 | 3.39 | 9.9 | 0.052 | 3.0 | 0.016 |

As shown in Table 1, in the high curing temperature ranges of 150° C. or higher, the charge trap density (|ρ|) increased as the curing temperature increased. This is thought to be due to the formation of a new charge trap center, which is caused by thermal decomposition of the (tetraphenyl)silole rings, as mentioned in the TGA and FT-IR results.

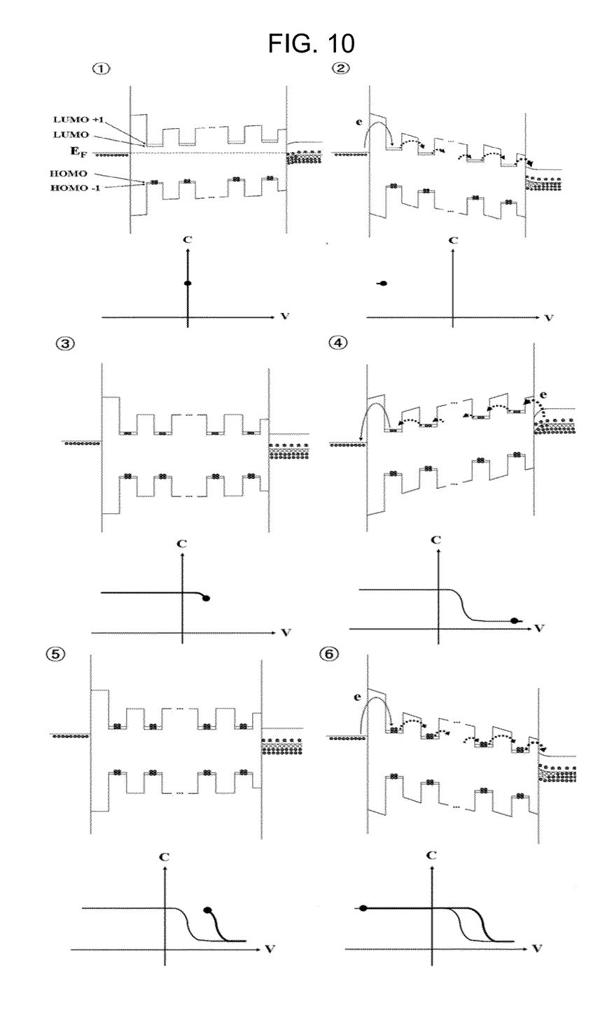

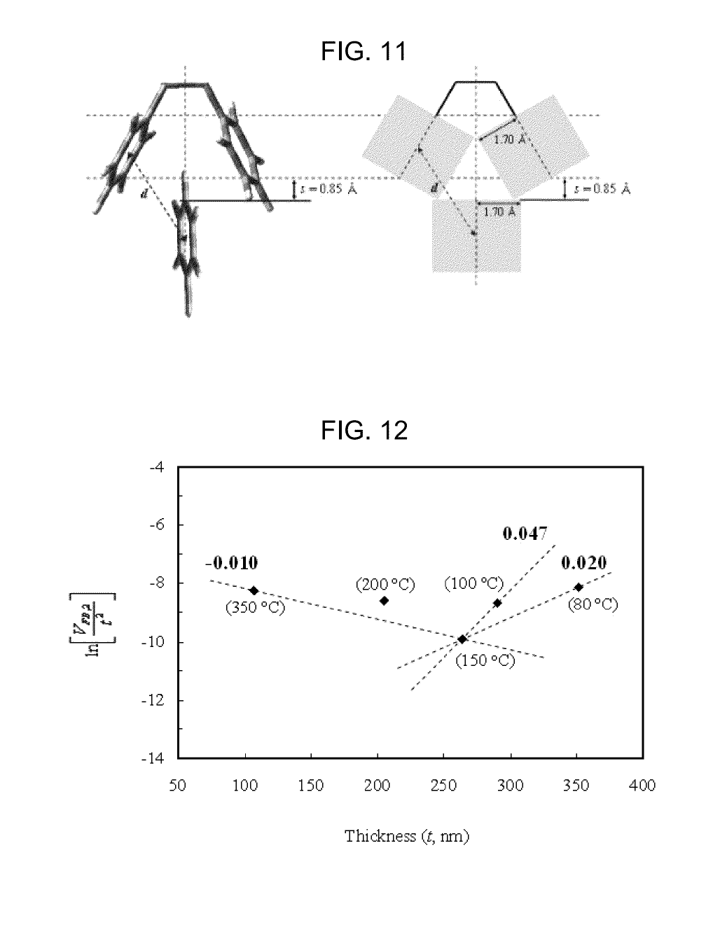

FIG. 10 depicts charge trap mechanisms of poly(tetraphenyl)silole siloxane thin films shown in the C-V curves. The samples above 150° C. was not interpreted due to thermal decomposition of organic groups therein. In addition, the energy barriers related to the interchain electron transfer were displayed instead of those of the intrachain electron transfer. For simplification, only few energy levels of HOMO, HOMO−1, LUMO, and LUMO+1 were displayed.

At negative bias condition (\textcircled{2}), electrons from the aluminum metal are injected into the LUMO level of the polymer through a tunneling mechanism, and transfer to unoccupied molecular orbitals or vibronically excited states of the LUMO level of another adjacent polymer through a resonant-tunneling mechanism. These transferred electrons are electronically or vibrationally de-excited into the LUMO level within a very short time. The interchain electron transfer enables the electrons to transfer to the polymer in the vicinity of the silicon substrate, where the electrons transfer into the conduction band of the p-type silicon substrate. Since the interchain electron transfer rates are expected to be the same, the charge trap density per unit volume may be in a steady-state condition. When the applied voltage is turned off, the electron transfer was stopped and the electrons are trapped in the polymer thin film, resulting in exhibiting positive ΔV_{FB} in the C-V curve (States \textcircled{3} \textcircled{4} of FIG. 10).

At positive bias condition (\textcircled{4}), the electrons in the doping level and the valence band of the silicon substrate are injected into the LUMO level of the polymer through a tunneling mechanism, and the electron transfer occurs in the opposite direction, like the negative bias condition. Finally, the electrons may transfer into the Fermi energy level of the aluminum metal.

The anticlockwise C-V hysteresis can be shown in the results of the 150° C.-cured sample, unlike the “as-prepared” sample and the 100%3-cured sample in FIG. 9. This anticlockwise C-V hysteresis means that the electron trapping in the reverse sweep condition (positive bias condition, \textcircled{4}) is higher than that in the forward sweep condition (negative bias condition, \textcircled{2}), which is confirmed by the charge trap density (|ρ|) in Table 1. This may be thought to be attributed to formation of a new conducting channel, which is caused by forming Si—O—Si linkages between the terminal Si—OH group of the polymer and the SiO₂ layer of approximately 15A on the silicon substrate. The tunneling through the O-bond has been known to be much faster than that through space. Therefore, the charge trap density IPI for the reverse sweep conditions, compared with the forward sweep conditions, relatively increases, due to injection of electrons through the O-bonds, resulting in C-V hysteresis. This assumption was applied in FIG. 7, where relatively low-energy barriers at the silicon substrate and the interface of the polymer were displayed.

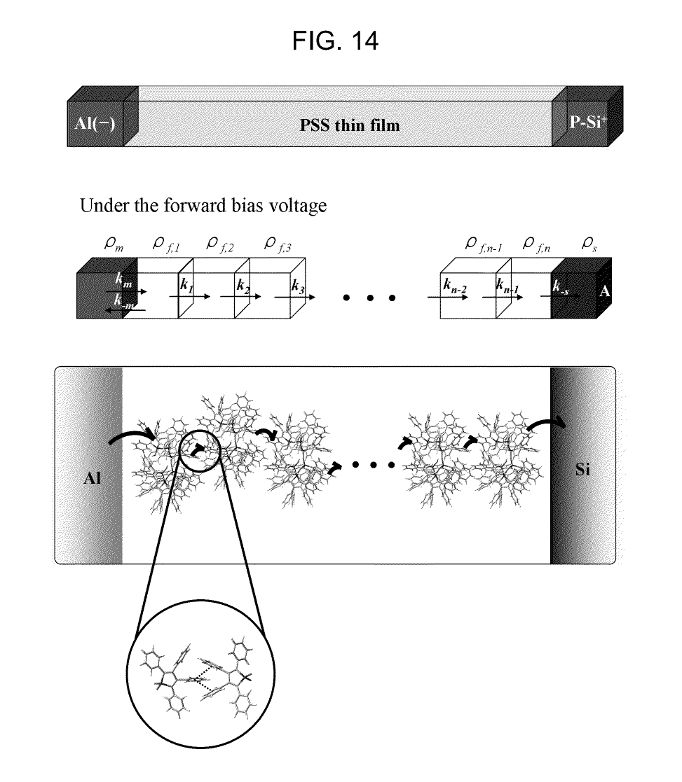

The electron transfer and trapping in the poly(tetraphenyl)silole siloxane thin film may be explained based on the following simple kinetics model. As shown in FIG. 14, the polymer thin film is supposed to be treated with a set of n volume elements, the area thereof is A and the thickness there of is approximately t/n (t is thickness of thin film). ρ_{f,n} denotes charge trap density for each volume element, and ρₘ, and ρₛ denote charge trap densities in metal and the semiconductor, respectively. km, k1, k2, . . . kn_1, and k₋ₛ are charge transfer rate constants in a direction from aluminum to silicon substrate under negative bias conditions.

Under the negative bias conditions, the steady-state approximation is applied for the charge trap density of the first volume element:

$$\begin{matrix}{ρ}_{m} {{{\to }_{←}}^{ {k}_{m }}}_{k} {ρ}_{f , 1} {\to }^{ {k}_{1 }} {ρ}_{j} & ( 11 ) \\ \frac{d {ρ}_{f , 1}}{d t} = {k}_{m} {ρ}_{m} - {k}_{m} {ρ}_{f , 2} - {k}_{1} {ρ}_{f , 1} = 0 & ( 12 ) \\ {ρ}_{f , 1} = \frac{{k}_{m}}{{k}_{m} + {k}_{1}} {ρ}_{m} & ( 13 )\end{matrix}$$

Assuming that the electron transfer rate constant (k₁) inside the poly(tetraphenyl)silole siloxane thin film is higher than that (k₋ₘ) from the polymer thin film to the aluminum electrode, k1>>k_m::

$${ρ}_{f , 1} = \frac{{k}_{m}}{{k}_{1}} {ρ}_{m} \qquad ( 14 )$$

For the second volume element:

$$\begin{matrix}{ρ}_{f , 1} = \frac{{k}_{m}}{{k}_{1}} {ρ}_{m} & ( 15 ) \\ \frac{d {ρ}_{f , 2}}{d t} = {k}_{1} {ρ}_{1} - {k}_{2} {ρ}_{f , 2} = 0 & ( 16 ) \\ {ρ}_{f , 2} = \frac{{k}_{1}}{{k}_{2}} {ρ}_{f , 1} & ( 17 )\end{matrix}$$

Assuming that electron transfer rate constant over all volume elements inside the poly(tetraphenyl)silole siloxane thin film are the same (k1=k2= . . . =kₙ₋₁):

ρ_{f,2}*ρ_{f,1} (18)

As a result of the above assumption, the charge trap densities for all volume elements are the same, except for the n-th volume element located right next to the silicon substrate (ρ_{f,n}=ρ_{f,2}=ρ_{f,3}= . . . ρ_{f,n-1}). For the n-th volume element:

$$\begin{matrix}{ρ}_{f , n - 1} {\to }^{ {k}_{n - 1} } {ρ}_{f , n} {\to }^{ {k}_{- s} } {ρ}_{s} & ( 19 ) \\ \frac{d {ρ}_{f , n}}{d t} = {k}_{n - 1} {ρ}_{f , n - 1} - {k}_{- s} {ρ}_{f , n} = 0 & ( 20 ) \\ {ρ}_{f , n} = \frac{{k}_{n - 1}}{{k}_{s}} {ρ}_{f , n - 1} & ( 21 )\end{matrix}$$

As mentioned above, if Si—O—Si linkages are present between the poly(tetraphenyl)silole siloxane polymer and the silicon substrate, the electron transfer rate constant (k₋ₛ) from the polymer to the silicon substrate may be higher than that (kₙ₋₁) between π organic groups (k₋ₛ>>kₙ₋₁). Accordingly:

ρ_{f,n}→ (22)

Overall:

$${ρ}_{f} = {ρ}_{f , 1} = {ρ}_{f , 2} = {ρ}_{f , 3} = … = {ρ}_{f , n 1} = \frac{{k}_{m}}{{k}_{1}} {ρ}_{m} \qquad ( 23 )$$

This is applied in the flat band shift relation:

$$\begin{matrix}Δ {V}_{FB , 2}^{f} ≅ - \frac{{ρ}_{f}}{{ɛ}_{0} \cdot {ɛ}_{OX}} \frac{1}{2} {t}^{2} & ( 24 ) \\ Δ {V}_{FB , 2}^{f} ≅ - \frac{1}{{k}_{1}} \frac{{k}_{m} \cdot {ρ}_{m}}{{ɛ}_{0} \cdot {ɛ}_{OX}} \frac{1}{2} {t}^{2} = C \cdot \frac{1}{{k}_{1}} \cdot {t}^{2} & ( 25 )\end{matrix}$$

The electron transfer rate constant inside the poly(tetraphenyl)silole siloxane thin film is thought to result from the interchain electron transfer rate constant of the polymer. The interchain electron transfer may occur thorough electron tunneling through two adjacent (tetraphenyl)silole rings, which is classified as electron transfer through space. The rate constant at this time has been known to exponentially decrease according to the distance. Assuming that a proportional constant is α:

$$\begin{matrix}{k}_{1} = α \cdot {e}^{- β \cdot d} & ( 26 ) \\ Δ {V}_{FB , 2}^{f} = C \cdot \frac{1}{α \cdot {e}^{- β \cdot d}} {t}^{2} & ( 27 )\end{matrix}$$

The “d” is a distance between phenyl rings on adjacent silole rings:

$$\frac{Δ {V}_{FB , 2}^{f}}{{t}^{2}} = C \cdot {α}^{- 1} \cdot {e}^{β \cdot d} \qquad ( 28 )$$

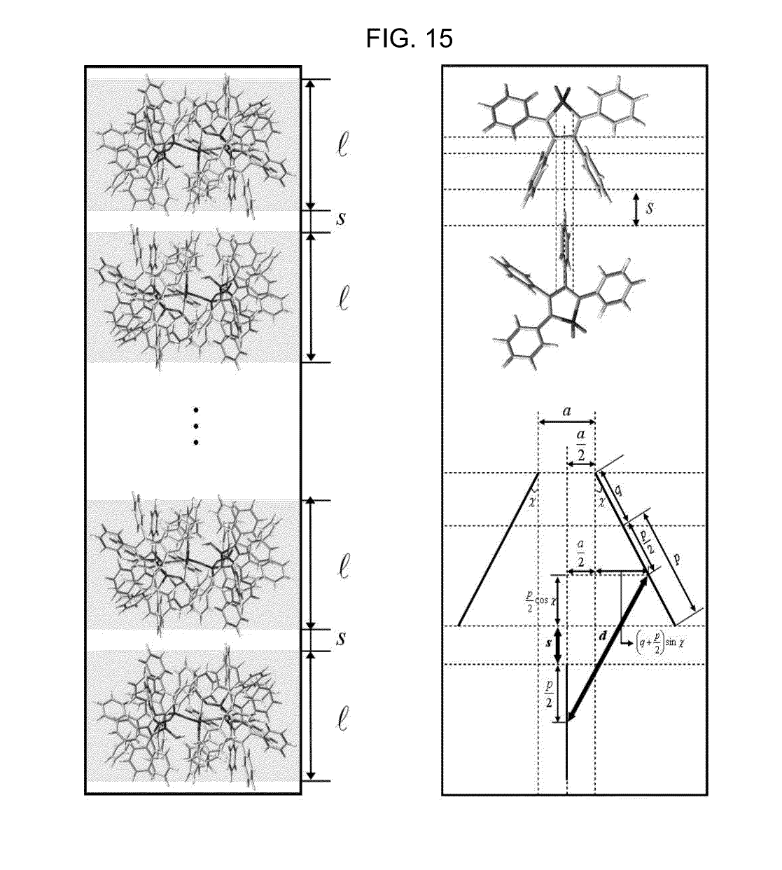

The assumption of n polymer sets arranged perpendicularly to the silicon substrate is schematized in FIG. 15. Here, l is length of volumes arranged perpendicularly to the substrate surface, and s is distance between the volumes in the same direction, Here, the carbon atoms were considered and the hydrogen (H) atoms were excluded.

$$\begin{matrix}t = n 𝓁 + ( n - 1 ) s ≅ n 𝓁 + n s & ( 29 ) \\ s = \frac{t}{n} - 𝓁 & ( 30 )\end{matrix}$$

Assuming that the interface between the volume elements is formed by the interactions of the phenyl rings, the geometrical relationship between d and s is as follows:

$$d = \sqrt{s ( s + p + p cos χ ) + {C}^{′}} , \\ {C}^{′} = q ( q + p ) {sin}^{2} χ + a ( q + \frac{p}{2} ) sin χ + \frac{{p}^{2}}{2} cos χ + \frac{1}{2} ( {p}^{2} + \frac{{a}^{2}}{2} ) \qquad ( 31 )$$

p, q, and χ were obtained from the geometrical structure optimized through DFT calculation, and were respectively 0.281 nm, 0.149 nm, 0.152 nm, and 30 o on average.

As shown in FIG. 11, by considering that a half (1.70 A) of the van der Waals thickness of the phenyl groups, the minimal value of s is estimated to be approximately 0.85 A. According to the existing paper on benzene-benzene interaction, it has been known that the edge-to-face type configuration allows for a shorter intermolecular distance by approximately 0.40 Å (2.50 Å versus 2.90 Å). In addition, for benzene dimmer, the intermolecular interaction potential energy and the intermolecular distance were calculated to be approximately 3.79 and 5.00 Å for the T-shaped and the parallel structures, respectively. Therefore, the intermolecular distance (d) between the phenyl groups of FIG. 11 may be in the range of 3.79˜5.00 Å. Here, s values of 0.48˜1.87 Å are calculated by using the relation between d and s.

Assuming that the “s” decreases further to approximately −0.1 nm and the maximal value of s is set to 0.2 nm (−0.100 nm<s<0.200 nm), the following relation may be obtained:

d≅0.803s+0.346 (nm) (32)

Substituting Equation (30) into Equation (32):

$$d ≅ 0.803 ( \frac{t}{n} - 𝓁 ) + 0.346 \qquad ( 33 )$$

Substituting Equation (33) into Equation (28), and taking the logarithm:

$$\begin{matrix}ln [ \frac{Δ {V}_{FB , 2}^{f}}{{t}^{2}} ] = ln ( C \cdot {α}^{- 1} ) + β \cdot d & ( 34 ) \\ ln [ \frac{Δ {V}_{FB , 2}^{f}}{{t}^{2}} ] = ln ( C \cdot {α}^{- 1} ) + β \cdot 0.803 ( \frac{t}{n} - 𝓁 ) + 0.346 & ( 35 ) \\ ln [ \frac{Δ {V}_{FB , 2}^{f}}{{t}^{2}} ] = [ ln ( C \cdot {α}^{- 1} ) - 0.803 β \cdot 𝓁 + 0.346 ] + \frac{0.803 \cdot β}{n} t & ( 36 )\end{matrix}$$

In FIG. 12,

$$ln [ \frac{Δ {V}_{FB , 2}^{f}}{{t}^{2}} ]$$

is plotted according to the thin film thickness (t). When comparing this graph with Equation (36),

$$\frac{0.803 \cdot β}{n}$$

may be estimated to be 0.047˜0.020 nm⁻¹ in the low-temperature ranges. As mentioned in the C-V results, the □V_{FB} value of the “as-prepared” sample is not accurately measured due to the measurable limit of bias voltage, and thus, it may be reasonable to take

$$\frac{0.803 \cdot β}{n}$$

value (0.047) for the 100□-cured and 150□-cured samples.

Even though the theoretical calculation of decay constant β for the interchain electron tunneling has not yet been executed, it can be estimated that the electron transfer in the poly(tetraphenyl)silole siloxane thin film occurs by cofacial π-π interaction between the phenyl rings inside the (tetraphenyl)silole. According to the recently presented papers, the decay constant between phenyl rings, β, was determined to be experimentally 12 nm⁻¹. By using this value, the number of volume elements (n) may be estimated to be approximately 205. Therefore, it can be seen that the total length (t/n) of volume elements at the 150° C.-cured sample is approximately 1.29 nm (Table 2). It can be seen that this value is close to the height approximately 1.39 nm) of the poly(tetraphenyl)silole siloxane organic-inorganic hybrid polymer (n=7) optimized through DFT calculation. By using Equations (30) and (31), the s and d values were also calculated for the 80° C.-, 100° C.-, and 150° C.-cured samples (Table 2).

TABLE 2
Interchain distance (s) and distance (d) between phenyl rings in the
low curing temperature range of 150° C. or lower

| | | | s(d) (nm) | | | | |
|---|---|---|---|---|---|---|---|
| | | | n = 6 | | n = 7 | | |
| | | | DFT | PM3 | | PM3 | n = 8 |
| | t | t/205 | (l = | (l = | DFT | (l = | PM3 |
| | (nm) | (nm) | 1.37) | 1.33) | (l = 1.39) | 1.24) | (l = 1.30) |
| 80 | 351 | 1.712 | 0.342 | 0.382 | 0.322 | 0.472 | 0.412 |
| | | | (0.643) | (0.681) | (0.624) | (0.767) | (0.709) |
| 100 | 290 | 1.415 | 0.045 | 0.085 | 0.025 | 0.175 | 0.115 |
| | | | (0.378) | (0.411) | (0.362) | (0.490) | (0.437) |
| 150 | 264 | 1.288 | −0.082 | −0.042 | −0.102 | 0.048 | −0.012 |
| | | | (0.285) | (0.312) | (0.273) | (0.381) | (0.334) |

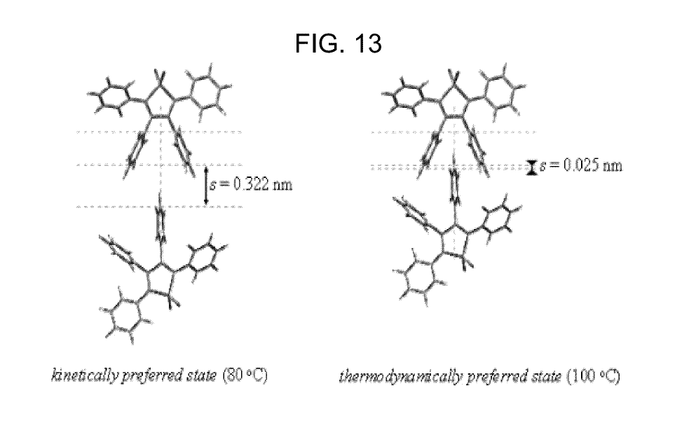

In the thermodynamically preferred state, the s and d values for the 80° C.-cured sample were calculated to be 0.322 and 0.624 nm, respectively, and the s and d values for the 100° C.-cured sample were calculated to decrease to 0.025 and 0.362 nm (FIG. 13). For the 100° C.-cured sample, it can be estimated that the molecular orbitals of the two phenyl rings overlap each other, since the s value (0.025 nm) was smaller than the distance (0.085 nm) when the van der Waals contact occurred.

In addition, it has been known that the decay constant β according to the distance for electron tunneling relates to the effective energy barrier (ΔE_{eff}) as follows:

β=(10.25 nm⁻¹ eV^{-1/2})\sqrt{ΔE_{eff}} (37)

Then, ΔE_{eff} is estimated to be approximately 1.4 eV, and this is somewhat close to the energy difference between the energy level of the LUMO orbital and the vacuum level in FIG. 3. It can be seen that this is consistent with the assumption that the interchain electron tunneling is mainly due to the cofacial π-π interactions between the adjacent phenyl rings.

As described above, the organic-inorganic hybrid polymer having quantum well structures according to the present invention allows charge trapping and transfer and has superior physical flexibility and electric stability, and the preparing process therefor is convenient. Therefore, the organic-inorganic hybrid material according to the present invention can be applied to TFT devices as charge storage memory typed flexible non-volatile memories in the future, and thereby to realize flexible non-volatile TFT memory devices.

What is claimed is:

1. An organic-inorganic hybrid polymer having quantum well structures, of Chemical Formula 1 below: 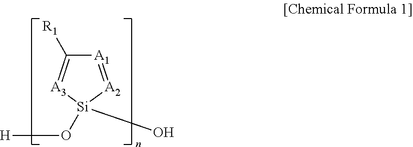
where in Chemical Formula 1, A₁, A₂, and A₃ each are CR₂, CR₃, CR₄, or N; R₁, R₂, R₃, and R₄ each are hydrogen, aryl, alkyl, cycloalkyl, heteroaryl, or may be linked to an adjacent substitution among R₁, R₂, R₃, and R₄ via C₃-C₇ alkylene or C₃-C₇ alkenylene to form a fusion ring; and n is a natural number of 2˜100.

2. The organic-inorganic hybrid polymer of claim 1, wherein the Chemical Formula 1 is poly(tetraphenyl)silole siloxane of Chemical Formula 2 below: 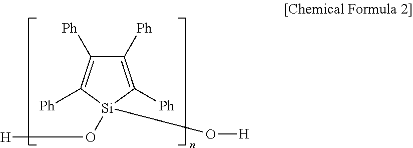
where, in Chemical Formula 2, n is a natural number of 2˜100.

3. The organic-inorganic hybrid polymer of claim 2, wherein the poly(tetraphenyl)silole siloxane has a weight average molecular weight (Mw) of 800˜50000.

4. The organic-inorganic hybrid polymer of claim 2, wherein at the time of application of external electric field, charges tunnel from a well layer to a barrier layer of the quantum well structure.

5. A thin film comprising the organic-inorganic hybrid polymer of claim 2.

6. The thin film of claim 5, wherein it is obtained by coating and curing a solution containing the organic-inorganic hybrid polymer.

7. The thin film of claim 6, wherein the curing is performed at 100° C.-350° C.

8. The thin film of claim 7, wherein it has a refractive index of 1.55˜1.62.

9. The thin film of claim 7, wherein it has a dielectric constant of 3.0˜3:5.

10. The thin film of claim 7, wherein it has ΔV_{FB} of 1˜20 V.

11. The thin film of claim 7, wherein it has charge trap density of 0.03˜0.06 C/cm⁸.

12. The thin film of claim 6, wherein it contains poly(tetraphenyl)silole siloxane, and a distance between two adjacent phenyl groups of (tetraphenyl) silole siloxane monomers of the poly(tetraphenyl)silole siloxane is 0.2˜0.5 nm.

13. An electronic device comprising the thin film of claim 5.

14. The electronic device of claim 13, wherein it is selected from the group consisting of organic thin film transistors (OTFT), non-volatile memories, sensors, logic circuits, memory circuits, tuning circuits, solar cells, flexible transistor devices, and flexible transistor memories.
